(19) United States
(12) Patent Application Publication
(10) Pub. No.: US 2008/0117177 A1
(43) Pub. Date: May 22, 2008

(54) ELECTRONIC DEVICES HAVING A TOUCH SCREEN AND METHOD FOR STARTING THE ELECTRONIC DEVICES

(75) Inventors: CHUNG-YANG KO, Tu-Cheng (TW); CHIN-FENG CHEN, Tu-Cheng (TW); TAY-YANG LIN, Tu-Cheng (TW); YUAN-HUNG CHIEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/843,661

(22) Filed: Aug. 23, 2007

(30) Foreign Application Priority Data
Nov. 20, 2006 (CN) 200610201106.3

(51) Int. Cl. G06F 3/041

(52) U.S. Cl. 345/173

(57) ABSTRACT

An exemplary electronic device (10) comprises a display (11), a chip controller (131), a power supply (14) and a main processor (12). The display has a capacitive touch screen (111). The power supply is electrically connected with and controlled by the chip controller. The main processor is electrically connected to the chip controller. The main processor is used to store a start operational input and calculate a touched signal that the touch screen is touched. The main processor further compares the touched signal with the start operational input to decide whether to send a start instruction to the chip controller to start the electronic device. The present invention further provides a method for starting the electronic device.

### CROSS-REFERENCE TO RELATED APPLICATIONS

This application is related to four co-pending U.S. patent applications (Attorney Docket No. US11801, US11802, US11804, US11805), all entitled “ELECTRONIC DEVICES HAVING A TOUCH SCREEN AND METHOD FOR STARTING THE ELECTRONIC DEVICES”, by Chung-Yang Ko et al. Such applications have the same assignee as the instant application and are concurrently filed herewith. The disclosure of the above-identified applications is incorporated herein by reference.

### BACKGROUND OF THE INVENTION

1. Field of the Invention

The present invention relates to electronic devices having a touch screen and methods for starting the electronic devices.

2. Discussion of the Related Art

Nowadays, electronic devices are popular and are used in a variety of situations. However, electronic devices also carry certain risks. For example, personal information stored in electronic devices such as mobile phones, personal digital assistants (PDAs) and personal computers may be stolen by others.

One typical electronic device includes an on/off key and a lock/unlock key. These keys can be actuated by anyone, thus, information stored in the electronic device can be easily accessed and used for malicious purposes. In order to keep information secured, passwords need to be inputted for turning on or unlocking the electronic device. However, inputting passwords often involves typing several letters and/or numbers on a keyboard, making the procedure very inconvenient.

Therefore, a need exist for electronic devices that can conveniently be turned on or unlock, to keep information secured, and the methods thereof.

### SUMMARY

An exemplary electronic device includes a display having a touch screen, a chip controller, a power supply and a main processor. The display has a capacitive touch screen. The touch screen includes a substrate, an electricity conductive layer, and a linear layer, lying on one another in that order, at least two electrodes being coated on two perpendicular sides of the linear layer. The electrodes are electrically connected to the main processor, and voltages of the electrodes are the same. The power supply is electrically connected with and controlled by the chip controller. The main processor is electrically connected to the touch screen, and the chip controller. The main processor is used to store a start operational input including at least one of a predetermined touched area, a predetermined touched duration, and a predetermined number of touched times and calculate a touched signal including at least one of touched position, touched duration, and number of touched times that the touch screen is touched. The main processor is used to further compare the touched signal with the start operational input to decide whether to send a start instruction to the chip controller to start the electronic device.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present electronic device and method for starting the electronic device, and associated electronic device. Moreover, in the drawings, like reference numerals designate corresponding parts throughout the several views, and all the views are schematic.

FIG. 1 is a schematic view of an electronic device in accordance with an exemplary embodiment of the present invention.

FIG. 2 is an exploded, schematic view of a touch screen of the electronic device in FIG. 1.

FIG. 3 is a view showing a working principle of a touch screen of the electronic device of FIG. 2.

FIG. 4 is a top plan view of the touch screen of FIG. 2 divided by imaginary lines.

FIG. 5 is a flow chart of starting the electronic device of FIG. 1.

### DETAILED DESCRIPTION OF THE EMBODIMENTS

The present invention provides an electronic device such as a mobile phone or a PDA, and a method for starting the electronic device.

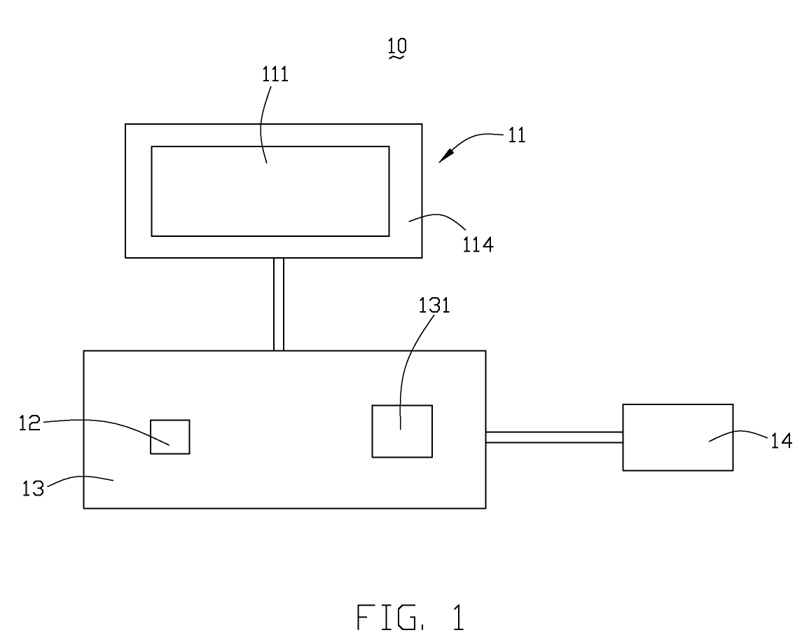

Referring to FIG. 1, an electronic device 10 includes a display 11, a main processor 12, a circuit board 13, and a power supply 14. The display 11 includes a frame 114 and a touch screen 111 confined in the frame 114. A chip controller 131 is mounted on the circuit board 13. The main processor 12 is mounted on the circuit board 13. The display 11 is electrically connected to the main processor 12 via the circuit board 13, and the power supply 14 is electrically connected to the chip controller 131 via the circuit board 13. The chip controller 131 is electrically connected to the main processor 12 via the circuit board 13. Alternatively, the main processor 12 can also be outside the circuit board 13 and directly connected to the display 11 and the power supply 14.

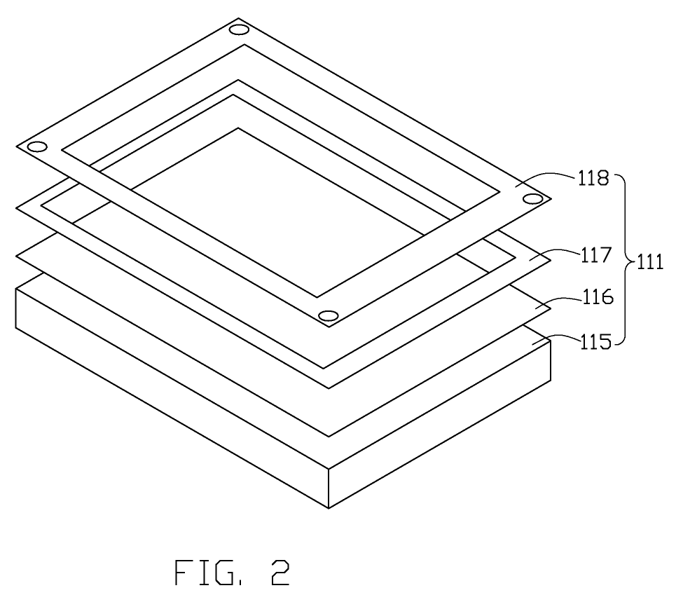

Referring to FIG. 2, the touch screen 111 is a capacitive touch screen. The display 11 further includes a glass substrate 115, an electricity conductive layer 116, a linear layer 117, and a protective layer 118 stacked on one another in that order. The conductive layer 116 is a film made of ATO (Antimony Tin Oxide, Sb₂O₃—SnO₂) coated on the substrate 115.

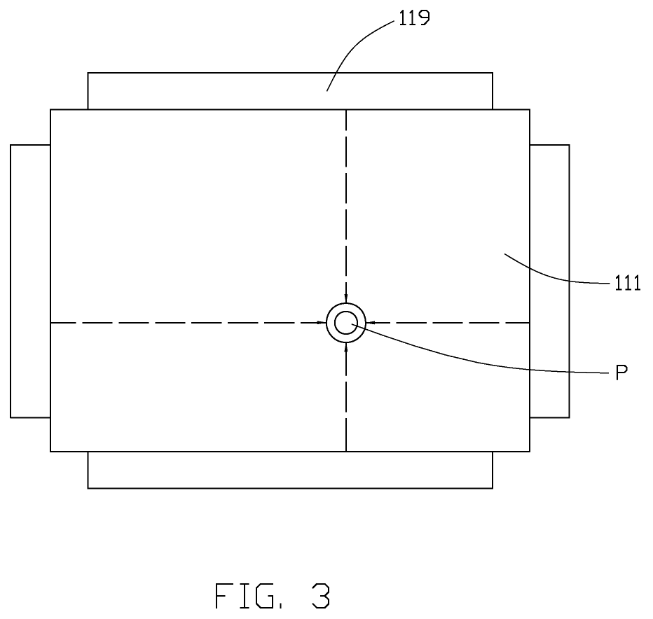

Referring to FIG. 3 an electrode 119 is coated on each of the four sides of the linear layer 117. The electrodes 119 are electrically connected to the main processor 12. The electrodes 119 generates an AC (alternating current) field on the conductive layer 116 while the main processor 12 monitors the current flow through each electrode 119. Voltages of the electrodes 119 are the same so that no electric current flows through the touch screen 111. The protective layer 118 is insulative and configured to protect the touch screen 111. If a user touches a point “P” of the touch screen 111 with his or her finger or a conductive stylus, capacitive coupling between the conductive layer 116 and the finger or stylus draws a small current from the electrodes 119. A value of the current from each of the electrodes 119 is in direct ratio to a distance from the finger or stylus to the electrode 119. The main processor 12 then calculates a touch coordinates of the point “P” from the ratio of the four currents. A touched duration of the touch can also be calculated by the main processor 12 according to how long the currents exist. Number of touched times (i.e., the touch screen 111 is touched for two times or three times etc.) of the touch can also be calculated by the main processor 12 according to the number of times the current is generated. Thereby, the main processor 12 calculates a touched signal including the touched area, the touched duration, and the number of touched times.

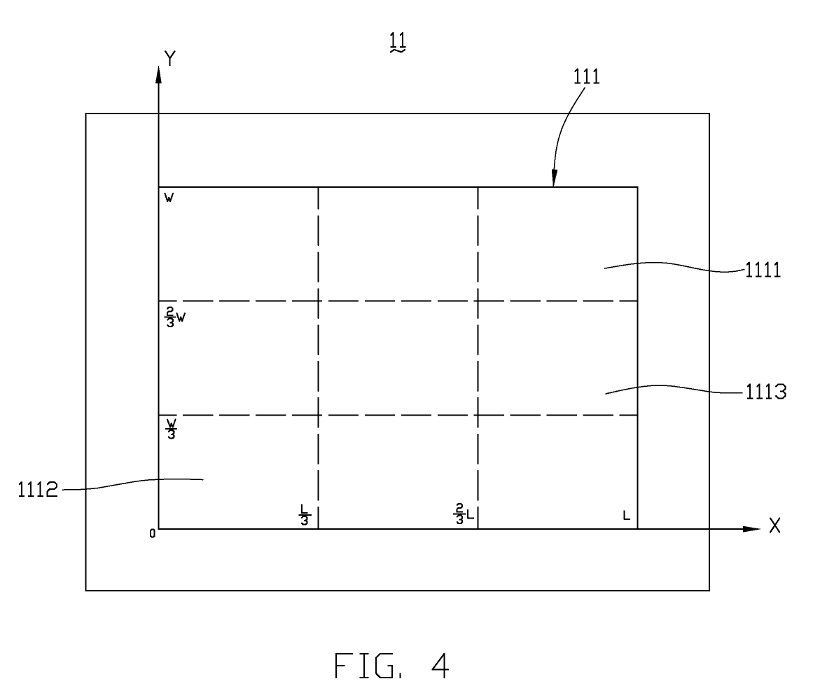

Referring to FIG. 4, the touch screen 111 of the electronic device 10, controlled by the main processor 12, is divided into several areas including areas 1111, 1112 and 1113. The touch screen 111 with a length of “L” in the X-direction and a width of “W” in the Y-direction is divided into nine areas, each of the nine areas having a length of “L/3” in the X-direction and a width of “W/3” in the Y-direction. Alternatively, the touch screen 111 can also be divided into any number of areas such as four or more than four areas. For each area, the area is regarded as touched when any point in the area is touched.

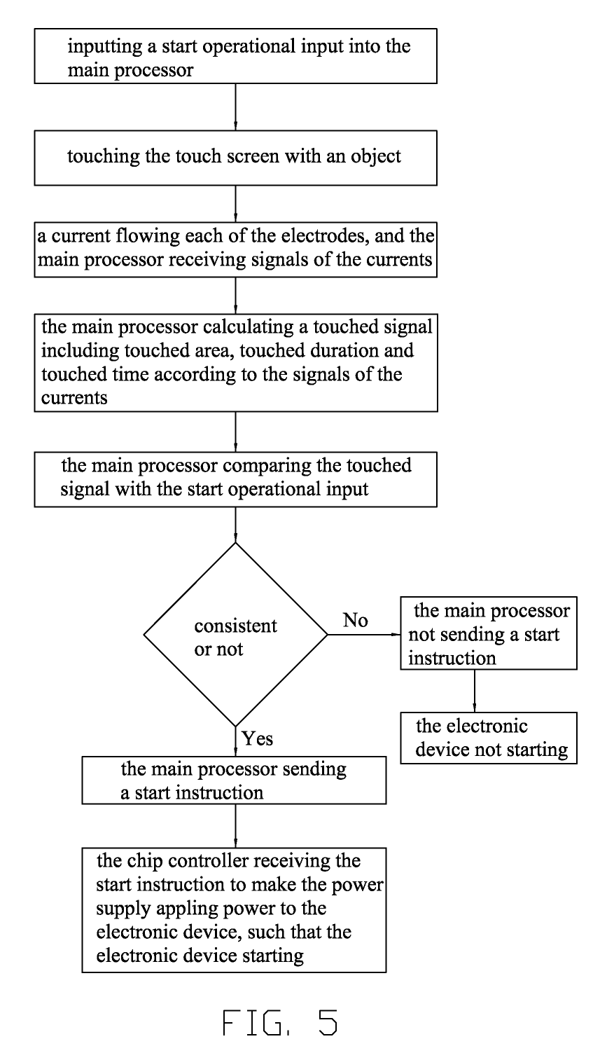

Referring to FIG. 5, a method for starting the electronic device 10 is provided as follows:
(1) A start operational input including a predetermined touched area, a predetermined touched duration, and a predetermined number of touched times is inputted into and stored in the main processor 12;
(2) A conductive object such as a finger or a conductive stylus touches the touch screen 111;
(3) As described above, the capacitive coupling between the conductive layer 116 and the finger or stylus draws a small current from the electrodes 119. The main processor 12 receives signals of the currents from the electrodes 119;
(4) The main processor 12 calculates a coordinate of the touched point according to values of the currents. The main processor 12 also calculates a touched duration and a number of touched times, thereby calculating a touched signal including the touched area, the touched duration, and the number of touched times; and
(5) The main processor 12 compares the touched signal with the start operational input. If the touched signal is the same as the start operational input, the main processor 12 generates and sends the start instruction to the chip controller 131 of the circuit board 13 to make the power supply 14 applying power to the touch screen 111. Then the electronic device 10 starts (including turn on or unlock). If the touched signal is different from the start operational input, the electronic device 10 does not start.

Referring to FIG. 4, the start operational input includes: simultaneously touching the areas 1111, 1112 for at least five seconds three times. That is, only when areas 1111, 1112 are simultaneously touched for at least five seconds three times, the main processor 12 sends a start instruction and the electronic device 10 starts. If areas 1111, 1113 are simultaneously touched for at least five seconds three times and are touched, the main processor 12 calculates the touched signal and compares the touched signal with the start operational input. The main processor 12 does not send any start instruction for starting the electronic device 10 because the touched area of the touched signal is not consistent with the predetermined touched area of the start operational input. If areas 1111, 1112 are simultaneously touched for three seconds three times, the main processor 12 does not send any start instruction for starting the electronic device 10 because the touched duration of the touched signal is not consistent with the predetermined touched duration of the start operational input. If areas 1111, 1112 are simultaneously touched for at least five seconds for twice, the main processor 12 does not send any start instruction for starting the electronic device 10 because the number of touched times of the touched signal is not consistent with the predetermined number of touched times of the start operational input.

The electronic device can also be started or unlocked by using one or two of the three predetermined touch values. In other words, the start operational input signal may be activated using one or two of the touch values instead of all three. For example, the start operational input includes the predetermined touched area, only. With this condition, no matter how long and how many times the touch screen 111 is touched as long as the touched position is consistent with the touched area of the start operational input, the main processor 12 sends the start instruction for starting the electronic device 10. Thus, only one start operational input is needed to turn on or unlock the electronic device 10. With this condition, the main processor 12 always compares the touched signal with the start operational input to turn on or unlock the electronic device 10. In another example, the start operational input includes two touch values, a predetermined touched area and a predetermined touched duration. With this condition, no matter how many times the touch screen 111 is touched as long as the touched position and the touched duration are consistent with the touched area and the touched duration of the start operational input, the main processor 12 sends the start instruction for starting the electronic device 10. Thus, only two values, of the start operational input, are needed to turn on or unlock the electronic device 10.

Additionally, a start operational input may be used for turning on the electronic device and a different start operational input may be used for unlocking the electronic device. With this condition, the main processor 12 compares the touched signal with one of the start operational inputs regarded as the turning on signal to turn on the electronic device 10 and compares another touched signal with the other start operational input regarded as the unlocking signal to unlock the electronic device 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device comprising:
a display having a capacitive touch screen, the touch screen comprising a substrate, an electricity conductive layer, and a linear layer, stacked on one another in that order, at least two electrodes being coated on two perpendicular sides of the linear layer, the electrodes are electrically connected to the main processor, voltages of the electrodes being the same;
a chip controller;
a power supply electrically connected with and controlled by the chip controller; and
a main processor electrically connected to the touch screen, and the chip controller, the main processor being used to store a start operational input including at least one of a predetermined touched area, a predetermined touched duration, and a predetermined number of touched times and calculate a touched signal including at least one of touched position, touched duration, and number of touched times that the touch screen is touched, the main processor being used to further compare the touched signal with the start operational input to decide whether to send a start instruction to the chip controller to start the electronic device.

2. The electronic device as claimed in claim 1, wherein the substrate is made of glass, and the conductive layer is an antimony tin oxide film coated on the substrate.

3. The electronic device as claimed in claim 1, wherein the display further comprises a protective layer located on the linear layer.

4. The electronic device as claimed in claim 1, wherein the display further comprises a frame for confining the touch screen.

5. The electronic device as claimed in claim 1, wherein the touch screen is rectangular in shaped and the linear layer has four sides, four electrodes are disposed at the four sides of the linear layer respectively.

6. The electronic device as claimed in claim 1, wherein the electrodes generates an alternating current field on the conductive layer, while the main processor monitors the current flow through each electrode, when a conductive object touches the touch screen, capacitive coupling between the conductive layer and the conductive object draws a small current from the electrodes, a value of the current from each of the electrodes is in direct ratio to a distance from the conductive object to the electrode, the main processor calculates a touched signal including touched area, touched duration, and number of touched times according to the currents.

7. The electronic device as claimed in claim 6, wherein the conductive object is a finger or a conductive stylus.

8. The electronic device as claimed in claim 1, wherein the touch screen comprises several areas defined by the main processor.

9. The electronic device as claimed in claim 1 further comprising a circuit board, the main processor and the chip controller are electrically connected with the circuit board.

10. The electronic device as claimed in claim 1 further comprising a circuit board, the chip controller is electrically connected with the circuit board, and the main processor is positioned inside the display.

11. A method for starting an electronic device comprising:
providing an electronic device comprising a display, a chip controller, a power supply and a main processor, the power supply electrically connected with and controlled by the chip controller, the main processor electrically connected with the chip controller, the display having a capacitive touch screen, the touch screen comprising a substrate, an electricity conductive layer, and a linear layer, lying on one another in that order, at least two electrodes being coated on two perpendicular sides of the linear layer, the electrodes are electrically connected to the main processor, voltages of the electrodes being the same;
inputting a start operational input including at least one of a predetermined touched area, a predetermined touched duration, and a predetermined number of touched times into the main processor;
touching the touch screen with a conductive object;
a current generated and flowing through each of the electrodes because of capacitive coupling between the conductive layer and the conductive object, and the main processor receiving signals of the currents generated and flowing through the electrodes;
the main processor calculating a touched signal including touched areas, touched duration and number of touched times according to the signals of the currents, and the main processor comparing the touched signal with the start operational input; the main processor sending a start instruction to the chip controller and the chip controller making the power supply applying power to start the electronic device if the touched signal being consistent with the start operational input.

12. The method as claimed in claim 11, wherein the substrate is made of glass, the conductive layer is an antimony tin oxide film coated on the substrate, and the display further comprises a protective layer located on the linear layer.

13. The method as claimed in claim 11, wherein the display further comprises a frame for confining the touch screen.

14. The method as claimed in claim 11, wherein the touch screen is rectangular shaped and the linear layer has four sides, four electrodes are disposed at the four sides of the linear layer respectively.

15. The method as claimed in claim 11, wherein the electrodes generates an alternating current field on the conductive layer, while the main processor monitors the current flow through each electrode, when the conductive object touches the touch screen, capacitive coupling between the conductive layer and the conductive object draws a small current from the electrodes, a value of the current from each of the electrodes is in direct ratio to a distance from a finger or stylus to the electrode.

16. The method as claimed in claim 11, wherein the touch screen comprises several areas defined by the main processor.

17. The method as claimed in claim 11 further comprising a circuit board, the main processor and the chip controller are electrically connected with the circuit board.
